(19) United States
(12) Patent Application Publication
(10) Pub. No.: US 2002/0174019 A1
(43) Pub. Date: Nov. 21, 2002

(54) Method for assisting a user in selecting and purchasing tires

(76) Inventors: Sheryl Walker Henderson, Simpsonville, SC (US); Stephen Taliaferro Bright, Atlanta, GA (US); Larry John Harris, Greenville, SC (US); Lillian B. Melvin, Simpsonville, SC (US); A. Kent Owens, Marietta, GA (US); Clyde A. Selleck III, Greenville, SC (US)

Correspondence Address: Michelin North America, Inc., Intellectual Property Department, P.O. Box 2026, Greenville, SC, 29602, US

(21) Appl. No.: 09/827,693

(22) Filed: Apr. 6, 2001

(51) Int. Cl. G06F 17/60

(52) U.S. Cl. 705/26; 707/6

(57) ABSTRACT

The invention relates to a method for assisting a consumer in selecting and purchasing tires through a computer based communication system. The system has data on a number of tires and requests from the consumer preferences for various attributes of tires, for example, comfort, handling, traction, tread wear, all-season use, etc. Using the set of preferred attributes, the system identifies a set of tires that most closely match the user's preferences, and presents information on the set of tires to the consumer. The consumer can send automatically a request to area retail dealers for price quotes on the tires or a selected tire from the set, and receive the quote directly from the dealer.

### BACKGROUND AND SUMMARY

The invention relates to a system and method for assisting a consumer in selecting and purchasing tires. More particularly, the invention is a method for using computer-based communications to provide relevant information to a consumer that allows the consumer to select tires having attributes most relevant to that consumer's preferences and for automatically putting that consumer in communication with one or more retailers who can provide the selected tires.

Interactive, computer-based systems that recommend products to consumers typically rely on product information provided by the manufacturer, and may supplement that information with “reviews” provided by other users. These sources of information may be viewed skeptically by a consumer. The manufacturer might be expected or perceived to “puff” its product, and is unlikely to publish any information indicating deficiencies in the product. Reviews provided by other purchasers may lack a basis for judging the criteria used for evaluation or the expertise of the user. Other known systems provide information about the sales of a product to an identified consumer group, and, as such, relate popularity information which only indirectly indicates the quality of the product. Where objective, test-based information is available, such as with consumer testing organizations, it is left to the user to sort through and to interpret the information for relevance, leading to the possibility of misunderstanding and error.

In purchasing tires, consumers have had to rely on the local retailer for recommendations, and usually find themselves limited to the brands carried at a particular location and sometimes limited to the available stock. A consumer today can use the Internet to gather information, but information beyond that provided by the manufacturer is rare, or not always conveniently obtained.

The present invention provides a system and method for providing relevant, objective, test-based information to a user to assist the user in selecting a tire for his or her vehicle. Through a series of questions, the system obtains information from the user to determine the correct size of the tire and vehicle type, and the tire performance characteristics important to the user. Using a database of information, including test-based information, on various tires, the system identifies and recommends to the user a set or group of tires from within the database of tires that best matches the user's needs and preferences.

The database includes data available from the tire manufacturer, including size, load rating, wear rating (UTQG), speed rating, along with data derived from objective testing of various tires for characteristics such as tread wear (for tires that do not include a UTQG rating), comfort or smooth ride, handling, cornering, snow and ice traction, wet traction, wet braking, off-road traction, ride noise, and hydroplaning resistance.

According to one aspect of the invention, the recommended tires are each presented with values reflecting the objective, test-based information from the database to permit comparison of the tires in the set. The values will thus show the user that one tire has a higher tread wear rating than another, or scored higher on a cornering or traction test, for example. The user can then use the values to select from the set the tire that best matches the user's preferences.

According to another aspect of the invention, each tire of the recommended set is given an overall score to indicate how the tire ranks relative to the other tires in the set according to the tested characteristics. The overall scores are preferably based on a sum of the objective test results weighted by the relative importance of each characteristic. The weightings could be determined through surveys of consumers who buy tires in a particular category, for example, SUV owners or luxury car owners. The scores may also be normalized relative to the highest sum obtained in the group, or to a theoretical “best” tire based on the highest individual characteristic scores for the tires in the group.

Alternatively, or in addition, overall scores for the tires may be weighted by the user's ranking of the importance of the objective test results, the method then including a step of accepting the user's ranking of the objective test results.

According to another aspect of the invention, the system locates retail dealers in the user's geographic area who carry the recommended tires, and invites the user to have a message requesting a price quote and availability sent automatically to the dealer. The quote from the dealer is returned through the system to shield the identity of the user, and so that the system can track dealer responsiveness.

These and other aspects of the invention will be better understood with reference to the following detailed description read in conjunction with the appended drawings.

### BRIEF DESCRIPTION OF THE DRAWINGS

FIG. 1 is a schematic of a communication system in accordance with the invention;

FIG. 2 is a flow diagram for a method in accordance with the invention for assisting a user in selecting and purchasing a tire;

FIG. 3 is a flow diagram of an interactive process to guide a user to a recommended group of tires showing three branches;

FIG. 4 is a flow diagram of the process of FIG. 3 showing details of a first branch;

FIG. 5 is a flow diagram of the process of FIG. 3 showing details of a second branch; and,

FIG. 6 is a flow diagram of the process of FIG. 3 showing details of a third branch.

### DETAILED DESCRIPTION

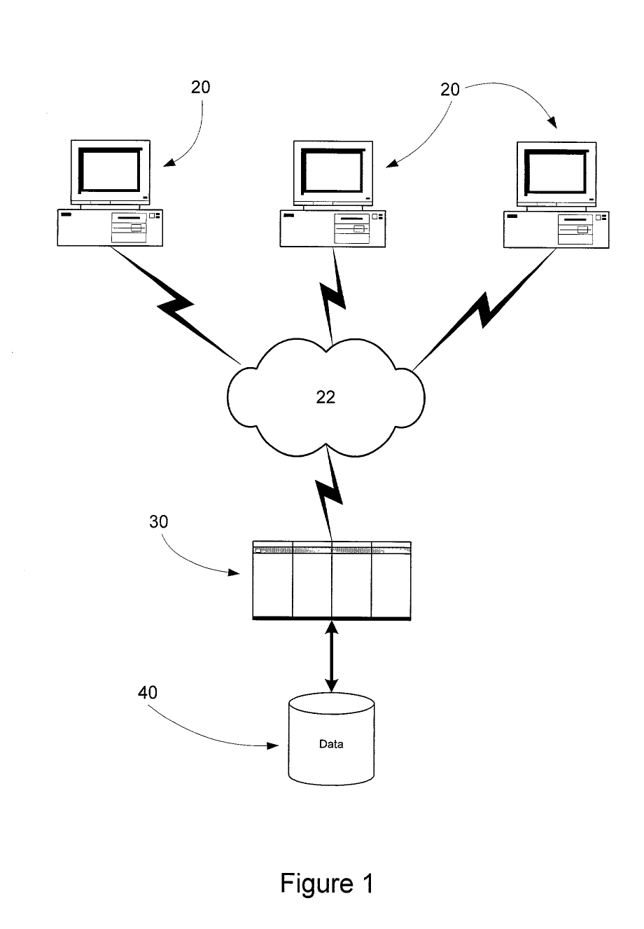

Referring to FIG. 1, a system for assisting a consumer or user in selecting and purchasing tires includes elements to establish communication between a user (using a computer 20) and a server 30. The communication link 22 can be via the internet, an internal network, a wired or wireless telephone connection, or any other suitable communication system.

The server 30 stores or has access to a database 40 containing information on a number of tire makes and models and information on retail sources for the tires. Retail source data includes the names, addresses, and telephone numbers of retail dealers, the hours of operation, and the brands carried at the dealer. Directions to the dealer's location may also be provided. The information relating to the tires is organized in three categories: fitment data, product data, and test data.

Fitment data is obtained from the manufacturer and includes the make, model, and size of a tire, and the vehicle class the tire is recommend for, for example, passenger car, sport performance, or light truck. Fitment data may also indicate specifically the vehicle or vehicles for which a particular tire is suited, in those instances where the tire manufacturer identifies tires for specific vehicle models.

Product data may include the brand names of tires, the product specifications provided by the manufacturer (including a UTQG standard tread wear rating, a speed rating, and load rating), the manufacturer's suggested retail price and/or a regional or national average price or a retail price range, a photograph or other image, and the manufacturer's own description of the tire's attributes.

Test data includes for each tire a value for certain performance characteristics such as wear (the DOT-required UTQG rating in passenger metric tires will be used without testing), comfort or smooth ride, handling, cornering, snow and ice traction, wet traction, wet braking, off-road traction, ride noise, and hydroplaning resistance.

According to the invention, test data is generated for each tire through objective testing of the tires. Preferably, the tests are standard, recognized tests for a particular characteristic, if available, or are tests designed to use readily available tools and techniques to ensure repeatability and confidence in the results. Other characteristics, such as comfort, handling and cornering, are derived from measured characteristics and from testing by trained drivers.

As mentioned, each tire in the database has associated with it a set of fitment, product, and test data. The set of data is used to identify the tire as belonging to a particular subset or group of tires sharing the same or similar characteristics, or otherwise related as being targeted by the manufacturer to a particular end user. A method in accordance with the invention groups tires in accordance with generally-recognized, broad market segments, and further divides these broad segments into additional levels of sub-segments according to pertinent data intended to better match a tire to a consumer needs and wants. For example, tires in the database are segmented broadly as light truck, passenger, or performance tires. Each of these segments is further divided by characteristics relevant to the segment, for example, light truck tires are further segmented according to the desired level of off-road traction: light, moderate, or heavy. Light truck tires with light off-road traction may be further divided into sets according to handling or ride characteristics: good road ride, all purpose handling, or sport handling.

The segmenting process may be done according to the number of tires and tire types in the database. According to the invention, a sufficient number of segments is created to provide the user or consumer with meaningful tire choices, that is, choices that relate specifically to the user's needs and desires. The segmenting process and how it facilitates the method of the invention will be better understood with reference to the description below. The designations used for the subsets are for the convenience of this description, and other designations could be substituted. In addition, the method of eliciting information through a pattern of questions represents a preferred embodiment of the invention. Others skilled in the art will recognize that other ways of eliciting information from a user could be substituted within the scope of this invention.

According to the invention, the user is asked through a series of related questions or selections to identify a preferred set of characteristics for tires for the user's vehicle. The set of characteristics gathered from the user identifies a particular subset of tires within the database. The identified subset is presented, or recommended, to the user, along with the data associated with each tire and a relative rating or score, for comparing the tires in the subset.

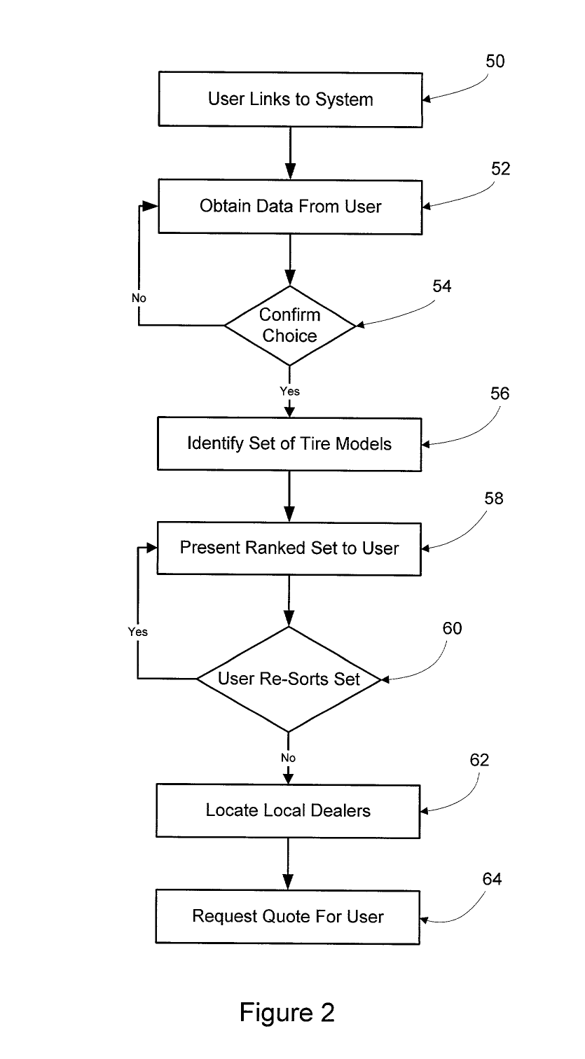

FIG. 2 illustrates a flow diagram of a preferred method in accordance with the invention. A user establishes communication with the server 30 through, for example, the Internet, at step 50. The system then obtains pertinent data from the user relating to the vehicle fitment and the user's preferred characteristics for tires at step 52. From the user data, a tire set is identified, at step 54, and the tires in the set are ranked and presented to the user, at step 58.

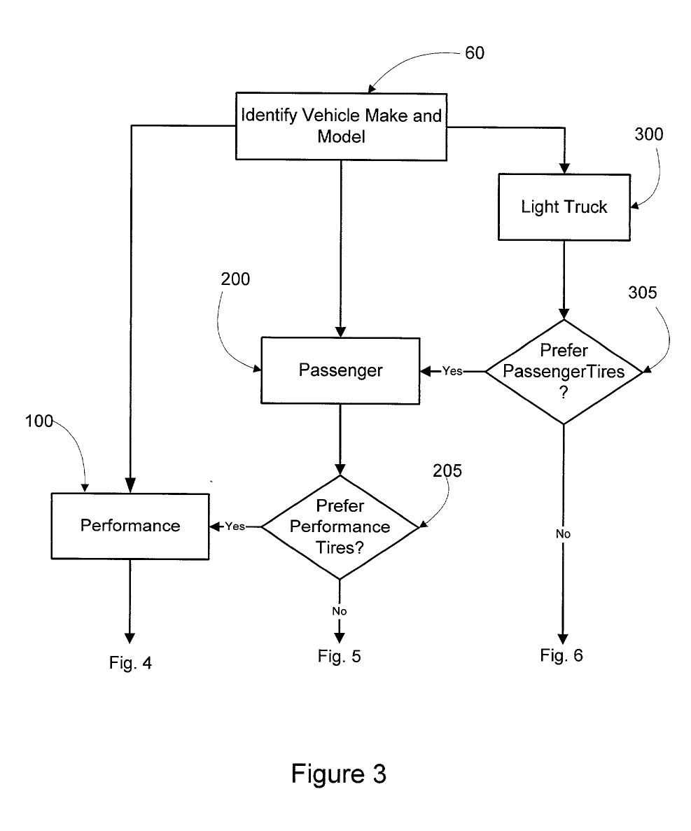

Referring to FIGS. 3-6, a preferred method of step 52 of obtaining pertinent data is by having the user respond to a series of questions posing various choices. Other methods, for example, a page having check off boxes could be used. As shown in FIG. 3, the user in a first step 60 is asked to identify the make, model, and year of manufacture of the vehicle. The vehicle information will generally indicate whether the vehicle takes performance 100, passenger 200, or light truck 300 tires. In some cases, however, the vehicle may allow the user to have a choice. Some light trucks, for example, can use passenger tires rather than light truck tires if the use is on road, rather than off-road. Certain passenger cars can use either general (mass-market) passenger or performance tires. In these situations, the system will include information identifying such vehicles, and the user will be asked to indicate a preference between light truck or passenger tires 305 or between passenger and performance tires 205. Thus, from the identification of the vehicle, and with additional information when appropriate, the user will be guided to one of three branches: performance 100, passenger 200, or light truck 300.

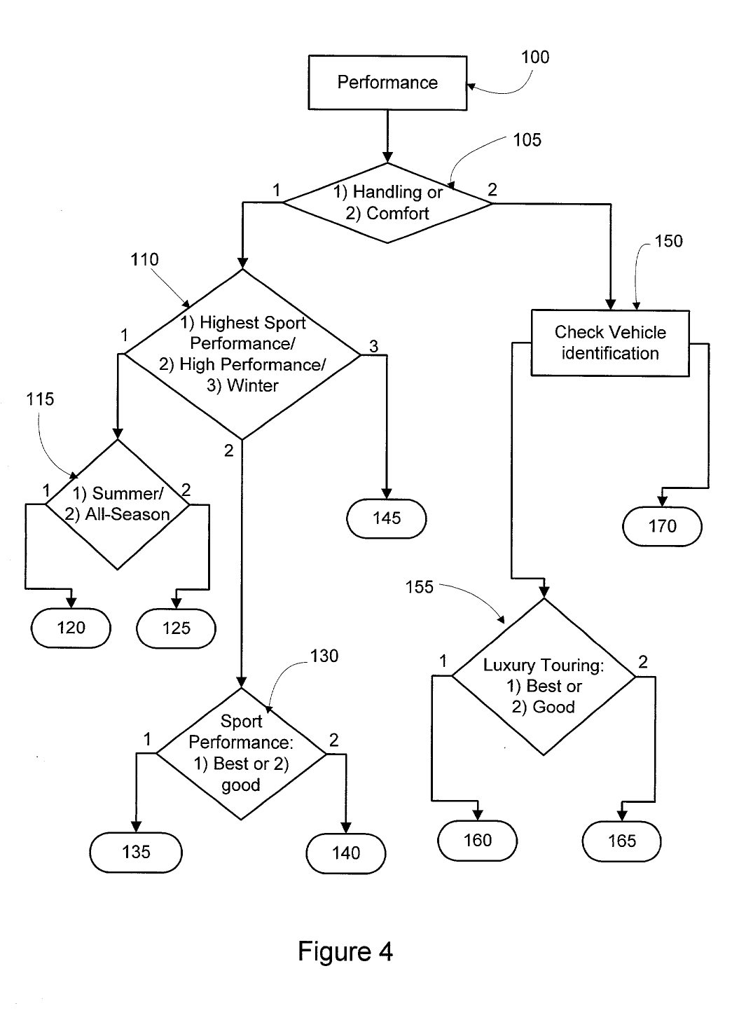

FIGS. 4, 5, and 6 show the choice patterns for each of the broad categories or branches, respectively, performance, passenger, and light truck according to a preferred embodiment of the invention. Within each branch, choices relevant to the tires represented by the branch will elicit the user's preferences for certain performance characteristics. The user will be asked to make choices between characteristics relating to price, handling, ride comfort, treadwear, all-season capability, traction, and sport performance. The choices force the user to indicate a preference of one attribute or characteristic as compared to one or two others. The choices are designed to obtain from the user a preference for a tire attribute that corresponds to data stored in the database. Each step along a branch, that is, each choice made the user, identifies a smaller subset of tires. Using the user's choices, a set of tires can be selected from the database, and a recommended set of tires presented to the user.

As shown in FIG. 4, a user who has identified a performance car, or indicated a preference for a performance tire, will be asked to indicate a preference 105 for either handling or comfort. If handling is selected, the user is guided to a choice 110 among “highest performance handling,” “high performance,” or “winter performance.” Users choosing highest sport performance would then be asked to indicate a preference 115 for either summer 120 or all-season 125 tires. Users choosing high performance would be asked for a preference 130 relating to price, choosing good 135 or best 140 high performance. The choice of winter performance leads directly to a group of winter performance tires 145.

On the other hand, if comfort is selected, the user will be guided 150 through a branch, either to luxury touring 155 or ultra high performance touring 170, according to the identified vehicle because tires in these categories have fitments specific to certain vehicle makes and models. In the luxury touring segment, the user will be asked for a preference relating to price, for the best 160 or a good 165 luxury touring tire.

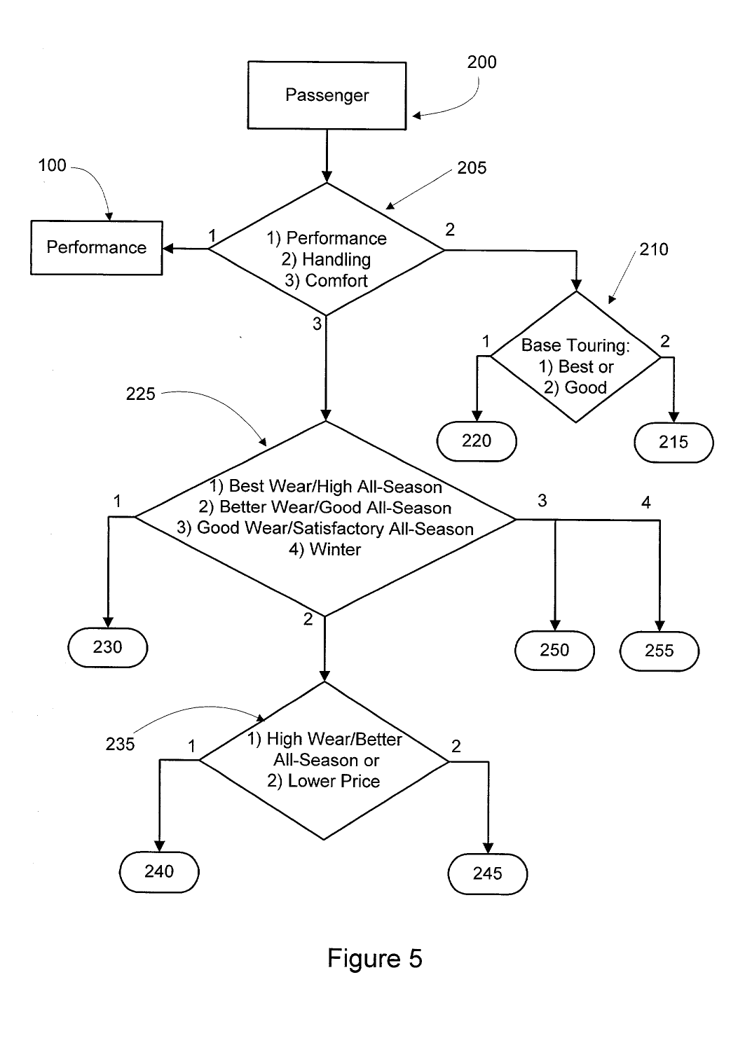

As shown in FIG. 5, a user selecting the passenger tire branch 200, would then be asked to indicate a preference 205 among handling, comfort, or high performance. The user preferring high performance will be directed to the performance branch 100, described in connection with FIG. 4. The user preferring handling will be then asked for a preference 210 relating to price, for a good 215 or best 220 handling tire. The user selecting comfort will be asked to indicate a preference 225 for tread wear and all-season capability (best, better, or good), or a preference for a winter tire. A best tread wear, highest all-season performance leads directly to a subset 230. The better tread wear/good all-season category selection requires a further selection 235 related to price, leading to a high 240 or mid 245 level tire in this category. A choice of good tread wear and satisfactory all-season performance leads directly to a subset 250, as does a choice of a winter tire 255.

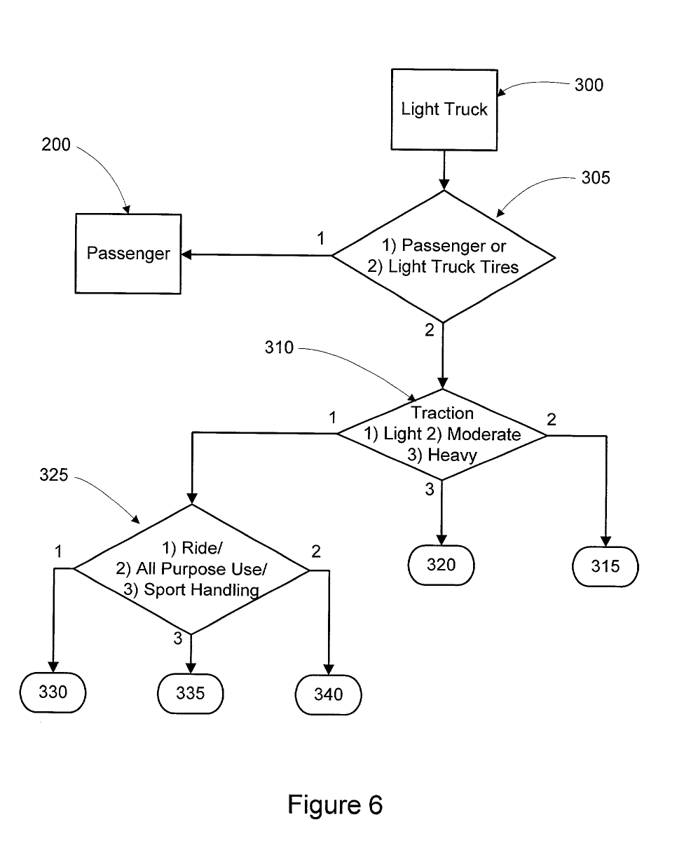

Referring to FIG. 6, the user indicating a preference for light truck tires will be asked 305, if appropriate for the vehicle, for preference between light truck and passenger tires. If passenger tires are indicated, the user will be directed to the passenger tire branch 200, described above in connection with FIG. 5.

Within the light truck branch 300, the user will be asked for a preference 310 for off-road traction, either light, moderate, or heavy. A preference for moderate 315 and heavy 320 traction leads directly to subsets for recommendation. A preference for light off-road traction leads to a choice 325 for car-like ride, all purpose use, or sport handling, each indicating a particular subset of tires, 330, 335, and 340, respectively.

Returning to FIG. 2, after the information is obtained from the user at step 52, the user may be asked at step 54 to confirm the choices made during the data collecting process. The individual choices are shown to the user, and the user given an opportunity to return to any particular choice, or confirm the set of choices. Once a set of choices is confirmed by the user, a particular subset of tires is identified at step 56, which, according to the described procedure, is the set identified at the end of one of the illustrated branches of FIGS. 4 to 6.

According to the invention, the system ranks tires in the identified subset according to the data associated with each tire. In a simplest embodiment, values for certain characteristics, for example, tread wear, wet braking, noise, cornering, comfort, are converted to a common scale to facilitate comparison, and presented to the user. In a further aspect of the invention, an overall score is calculated and presented along with the tire data. The overall score may be a simple sum of the converted scores, or may be normalized by dividing by the highest sum for all the tires in that set to arrive at a relative score.

A preferred manner of converting the characteristics values to a common scale is to convert each value to fit within a range of plus or minus two units relative to an average value for all the tires in that group. The converted values may be presented to the user in any comprehensible format, for example, using graphic symbols or numerical values, or both. A numerical value advantageously allows for further calculations of a relative overall score. A numerical scale, of, for example, 1 to 5, may be imposed on the range of −2 to +2. Thus, for example, a value for a particular tire for any characteristic will have a scaled score in a range of 1 to 5 (with 3 being average) relative to the tires within that group, which facilitates comparing the tires in the group. For example, if a group of four tires have UTQG tread wear ratings of tire A=400, tire B=300, tire C=360 and tire D=360, an average for the group is 355 and the range of lowest-to-highest is 100. Imposing a range of −2 to +2 and a scale of 1 to 5 about the average of 355 scales the scores to approximately tire A=5, tire B=1, tire C=3, and tire D=3. To avoid confusion about which end of the scale represents a better score (which can happen with scales including “1” and/or “10”) the range for the scale could run, for example, from 3 to 7.

A further preferred method includes incorporating a relative weighting for each of the scaled characteristic values. A weighting could be obtained through consumer survey data, for example, how consumers rank each of the characteristics, wet braking, noise, cornering, etc., on a scale of one to ten. Alternatively, the weighting could be derived simply on how consumers order the characteristics for importance. Each of the scaled values is multiplied by an average weighting value to obtain a weighted score for that characteristic.

An overall score could then be calculated as the summation of the weighted scores. The overall weighted score could be used as is, or normalized to the highest scoring tire in the group, or to a theoretical “best” tire being a composite of the highest individual scores of the tires. Thus, the score for each tire in the selected group could be given as a percentage of the score of the highest scoring tire in the group, or as a percentage of a theoretically highest scoring tire.

In addition, or in the alternative, to using consumer survey data to obtain the weighting values, the user could be asked to provide his or her own weighting value step 60, ranking the tire characteristics according to relative importance to her or giving each a relative importance value. The scaled values could be multiplied by the weighting value to present to the user tire scores having particularly personal relevance.

### EXAMPLE

Table 1 shows a theoretical set of tires selected by a user after providing information through the process of FIGS. 3-6. The scores of the various characteristics have been converted to a common scale of 1 to 5 as described above. A theoretical “best” tire is shown having the highest characteristic values of the tire set. The weighting values are shown in the last column on the right.

TABLE 1

| Tire characteristic | Tire A | Tire B | Tire C | Tire D | “Best” Tire | Weight |
|---|---|---|---|---|---|---|
| wet braking | 2 | 5 | 2 | 3 | 5 | 6 |
| noise | 4 | 3 | 3 | 2 | 4 | 5 |
| comfort | 3 | 3 | 3 | 2 | 3 | 6 |
| cornering | 3 | 3 | 3 | 3 | 3 | 10 |
| wear | 5 | 1 | 3 | 3 | 5 | 6 |
| sum of (score × weight) | 110 | 99 | 93 | 88 | 128 | |
| overall score normalized | 100 | 90 | 85 | 80 | | |
| (sum/highest sum) × 100 | | | | | | |
| overall score vs. theoretical | 86 | 77 | 72 | 69 | 100 | |
| (sum/“best” sum) × 100 | | | | | | |

A tabular format similar to that above, or another suitable format, may be used to present the tire recommendations to the user. For each tire, the scores for the various characteristics are presented, along with an overall score. The overall score indicates how the tire rates compared to the other tires in the recommended set of the tires. In addition, a price level (premium, mid-price, economy) could be presented, or a regional or national average retail price or a price range may be presented. The scores for individual characteristics are, as mentioned, derived from the objective test data stored in the database. The user can then compare, side by side, the tires from the set selected through the choice procedure using relevant, objective data.

Alternatively, the user may change the weights for the characteristics to better reflect the user's ranking of the importance of the characteristics. The scale shown in Table 1 is a simple 1 to 10 scale. The user would enter his weighting values in each of the rows, and a new set of scores would be calculated and reported.

As shown in FIG. 2, the user will have the choice of requesting automatically quotes from area retail dealers for the tires of the selected set. Using the user's zip code or other area identifier, the system will select the geographically closest dealers who carry one or more of the selected tires. The geographic proximity can be predetermined or selected by the user. The system will identify to the user dealers for the recommended tires and ask the user which dealers, if any, should be contacted for a price quote. The user can select one or all of the dealers. The system will then send an electronic message to the selected dealer or dealers for price quotes on the relevant recommended tires. The system conveniently locates a dealer for the user, and eliminates the need for the user to look up dealers and contact them for information.

The quote from the dealer, and any other information the dealer may want to provide, such as sale pricing, service specials, etc., will be returned to the user via the system. This allows the system to monitor dealer responsiveness to ensure satisfaction for the user. After the quote is delivered, further communication and dealings are directly between the user and the dealer chosen by the user.

The invention has been described in terms of preferred principles, embodiments, and features, however, those skilled in the art will recognize that various equivalents may be substituted without departing from the scope of the invention as defined in the following claims.

What is claimed is:

1. A method for assisting a user in selecting and purchasing tires using computer-based communication, comprising the steps of:
providing a database of tires, including at least information on vehicle fitment and performance characteristics;
obtaining from the user information to determine vehicle fitment and the user's preferences of performance characteristics for the tires;
selecting from the database, responsive to the information obtained from the user, a set of tire models corresponding to the vehicle fitment information and which most closely match the user's preferred performance characteristics; and,
displaying to the user information and performance characteristics for the selected set of tires to permit comparison of the tires.

2. The method as claimed in claim 1, further comprising the step of displaying to the user names and locations of dealers for the selected set of tire models.

3. The method as claimed in claim 2, further comprising the step of requesting a price quote from a dealer to be delivered directly to the user for at least one of the selected set of tire models.

4. The method as claimed in claim 1, wherein the step of displaying information and characteristics of the selected set of tire models includes calculating and displaying a score indicating how each tire ranks within the selected set of tire models.

5. The method as claimed in claim 1, further comprising the step of re-ordering the display of the selected set of tire models according to user provided criteria.

6. The method as claimed in claim 1, wherein the step of providing the database includes the step of testing tires to obtain performance data characteristics, including at least noise, cornering, hydroplaning resistance, wet braking, and traction performance.

7. The method as claimed in claim 1, wherein the step of providing the database includes the step of storing manufacturer data for each tire on make, model, size, vehicle fitments.

8. The method as claimed in claim 1, wherein the step of obtaining information from the user includes posing a series of questions to the user to elicit desired information, each question requiring a choice between at least two characteristics, wherein, said characteristics correspond to characteristics associated with the tires stored in the database.

9. The method as claimed in claim 8, wherein tires are selected from the database according to a set of responses to the questions.
